(19) United States
(12) Patent Application Publication
(10) Pub. No.: US 2005/0274169 A1
(43) Pub. Date: Dec. 15, 2005

(54) Vehicle/engine sampling system for precise analysis of exhaust components

(76) Inventors: James Butler, Livonia, MI (US); Alex Colvin, Oak Park, MI (US); Thomas Korniski, Livonia, MI (US); Christine Gierczak, Grosse lle, MI (US)

Correspondence Address: KILLWORTH, GOTTMAN, HAGAN & SCHAEFF, L.L.P., ONE DAYTON CENTRE, ONE SOUTH MAIN STREET, SUITE 500, DAYTON, OH, 45402-2023, US

(21) Appl. No.: 10/865,380

(22) Filed: Jun. 10, 2004

(51) Int. Cl. G01N 1/00; G01N 35/00

(52) U.S. Cl. 73/23.2

(57) ABSTRACT

An apparatus and method of exhaust gas analysis. It includes maintaining a gas sample at a constant temperature and at a constant pressure and maintaining a constant gas sample delay time.

### BACKGROUND OF THE INVENTION

The present invention generally relates to exhaust gas analysis, and more particularly to an exhaust gas analysis method and apparatus having a constant sampling rate.

Frequently in exhaust gas analysis, the absolute level of a component in the gas phase sample is of interest. For example, it is often necessary to measure the real-time mass emission rates of certain regulated components in vehicle exhaust. In order to calculate the mass of the component from a relative measurement such as concentration, a precise time alignment of the concentration value and the volume or flow rate of the exhaust must be made. Delay times associated with transporting a sample of the exhaust gas from the source to the gas analyzer must remain constant despite changes in the system environment. However, due to the nature of the sampling arrangements employed in conventional systems, sample delay times are affected by changes in atmospheric pressure due to weather or altitude encountered during testing, especially during real world driving. Thus, as changes in atmospheric pressure occur, the differential between the instrument sample pressure and the atmospheric pressure will change. These changes may result in changes in the transport delay time of the sample and thus, the misalignment of the data used to calculate the mass emission rates, thereby making the system inaccurate.

Therefore, there remains a need for an improved method and apparatus for an exhaust gas analysis system.

### SUMMARY OF THE INVENTION

The present invention meets this need by providing an apparatus and method which provide a controlled, representative sample of vehicle exhaust to a variety of analytical instruments independent of temperature, pressure, and engine operating conditions at altitudes up to 14,000 feet.

To compensate for atmospheric pressures changes, the present invention utilizes a reduced pressure (relative to atmospheric pressure) sampling technique to maintain a gas sample at constant temperature and pressure, which are independent of the vehicle's exhaust temperature and pressure. Consistency in sample delay times is maintained preferably by regulating the power supply to the sample pump, thereby regulating pump speed, in order to maintain constant gas sample delay times at various atmospheric pressures.

In one embodiment, the exhaust gas analysis system includes a temperature control system maintaining a gas sample at constant temperature; a pressure control system maintaining the gas sample at constant pressure; a gas analyzer analyzing the gas sample; a vacuum pump transferring the gas sample to the gas analyzer; and a delay time control system maintaining a constant gas sample delay time through the exhaust gas analysis system.

Another aspect of the invention is a method for exhaust gas analysis. The method includes providing a gas sample for analysis; maintaining the gas sample at constant temperature; maintaining the gas sample at constant pressure; providing a gas analyzer; maintaining a constant gas sample delay time through the exhaust gas analysis system; and analyzing the gas sample in the gas analyzer to provide a concentration of a gas species.

### BRIEF DESCRIPTION OF THE DRAWINGS

The present invention can be carried into practice in various ways but several embodiments will now be described by way of example, and with reference to the accompanying drawings in which:

FIG. 1 is a block diagram of the experimental set-up used for the first part of the pressure study.

FIG. 2 is a block diagram of the experimental set-up used for the second part of the pressure study.

FIG. 3 is a block diagram of the experimental set-up used for the third part of the pressure study.

FIG. 4 is a diagram of one embodiment of pulse width modulated pump control circuitry useful in the present invention.

FIG. 5 is a diagram of one embodiment of constant delay time motor control circuitry useful in the present invention.

FIG. 6 is a block diagram of one embodiment of an exhaust gas analysis system according to the present invention.

FIG. 7 is a diagram of one embodiment of pressure control circuitry useful in the present invention.

### DETAILED DESCRIPTION OF THE INVENTION

The exhaust gas analysis system of the present invention samples and analyzes vehicle exhaust. The exhaust gas analysis can optionally be combined with vehicle parameter data from the Powertrain Control Module (PCM). The exhaust gas analyses, in terms of concentrations, can be combined with the data from the PCM to calculate mass emission rates. Precise time alignment of the exhaust gas concentrations measured by the exhaust gas analysis system and the PCM data is desirable to calculate these emission rates accurately.

In order to calculate the mass of a component from a relative measurement, such as concentration, a precise time alignment of the concentration value and the exhaust volume or exhaust flow rate of the sample is made. Delay times associated with transporting the sample from the source to the gas analyzer should remain constant despite changes in the system environment. When real-time mass emission rates of an emission component in vehicle exhaust are measured while the vehicle is driven in mountainous areas where changes in altitude result in ambient pressure changes, the sample delay times associated with the gas analysis system should remain constant so that a correct product of concentration and exhaust flow rate is obtained.

A series of studies was undertaken to evaluate the changes in the sample delay times that occur as a result of atmospheric pressure changes that might be encountered during real world driving. The pressure study encompassed atmospheric pressures ranging from 725 mbar to 975 mbar, which correspond to altitudes ranging from slightly above sea level (about 1000 ft) to as high as 8500 ft. The effects of changes in instrument (sample) pressures on sample delay times were also examined. These studies were conducted under various atmospheric pressure conditions which indicated that atmospheric pressure changes on the order of about 100 mbar can change sample delay times through the instrument by as much as one second or more. The accuracy of the mass emission rates generated during real-world driving studies conducted in mountainous regions could suffer measurably from such deviations in sample gas delay times. Therefore, a delay time control system is used to maintain constant sample gas delay times. The delay time control system may be a power supply regulator controlling power supplied to the pump. Circuitry to do so was developed. The circuits were validated via laboratory testing. The circuit diagrams and the results of the validation testing are presented and discussed below, although other circuitry and other delay time control systems could be used.

Experiment 1

FIG. 1 is a block diagram of the experimental set-up used for Experiment 1 of the pressure study. The set-up included a way to control and monitor the simulated atmospheric pressures using several components that were located peripheral to the exhaust gas analysis system.

As depicted in FIG. 1, the inlet 10 and the outlet 15 of the exhaust gas analysis system 20 were joined together. The details of the exhaust gas analysis system 20 are discussed below. A mass flow meter 25 was inserted between the inlet 10 and the outlet 15 to monitor the sample flow rate through the system. An auxiliary pressure control system 30 including a 12V vacuum pump 35, ballast 40, pressure control circuit 45 (similar to the circuit used internally on the exhaust gas analysis system), pressure control valve 50, air leak valve 55, and absolute pressure gauge 60, was added external to the exhaust gas analysis system 20 to simulate atmospheric pressures less than the actual atmospheric pressure of 990 mbar. All connections were made using ¼″ Teflon or silicon tubing. The pump speed and sample pressure for the exhaust gas analysis system were controlled through pump control circuitry 65 and pressure control circuitry 70 in the exhaust gas analysis system 20.

Experiment 1 examined the behavior of the exhaust gas analysis system at three different atmospheric pressure levels, at the actual atmospheric pressure of about 990 mbar, and two simulated pressures of about 900 and about 800 mbar. Adjustments to the pump voltage were made while sample flow rates and the ability of the system to maintain the desired sample pressure were monitored and recorded. The data acquired are presented in Tables 1, 2, and 3.

TABLE 1
Atmospheric Pressure of about 990 mbar

| Absolute | Pump Duty Cycle | Pressure | | Exhaust Gas |
|---|---|---|---|---|
| Pressure Meter | (%) & | Board | Sample | Analysis System |
| Reading | Pump Voltage | Setting | Pressure | Pressure Control |
| (mbar) | (V) | (%) | (mbar) | Circuit Status* |
| 990 | 100%/12.3 V | 38 | 891 | C |
| | | 40 | | NC |
| 990 | 69%/10.3 V | 20 | 820 | C |
| | | 37 | 887 | C |
| | | 38 | 891 | C |
| | | 39 | 895 | C |
| | | 40 | 900 | C |
| | | 42 | 907 | C |
| | | 43 | | NC |
| 990 | 55%/8.3 V | 42 | 907 | C |
| | | 44 | 915 | C |
| | | 45 | 919 | C |
| | | 46 | | NC |

*C = Controlling NC = Not Controlling

At an atmospheric pressure of about 990 mbar and a pump duty cycle setting of 100% (12.3V), the exhaust gas analysis system pressure control circuit failed to control the sample pressure at pressure board settings greater than 38 (corresponding to a sample pressure of about 891 mbar). At this atmospheric pressure, pump duty cycle setting, and sample pressure, the flow rate through the exhaust gas analysis system was about 6.6 L/min.

At an atmospheric pressure of about 990 mbar and a pump duty cycle setting of 69% (10.3V), the exhaust gas analysis system pressure control circuit failed to control the sample pressure at pressure board settings greater than 42 (corresponding to a sample pressure of about 907 mbar). At this atmospheric pressure, pump duty cycle setting, and sample pressure, the flow rate through the exhaust gas analysis system was about 5.7 L/min.

At an atmospheric pressure of about 990 mbar and a pump duty cycle setting of 55% (8.3V), the exhaust gas analysis system pressure control circuit failed to control the sample pressure at pressure board settings greater than 45 (corresponding to a sample pressure of about 919 mbar). At this atmospheric pressure, pump duty cycle setting, and sample pressure, the flow rate through the exhaust gas analysis system was about 4.8 L/min.

TABLE 2
Simulated Atmospheric Pressure of about 900 mbar

| Absolute | Pump Duty Cycle | Pressure | | Exhaust Gas |
|---|---|---|---|---|
| Pressure Meter | (%) & | Board | Sample | Analysis System |
| Reading | Pump Voltage | Setting | Pressure | Pressure Control |
| (mbar) | (V) | (%) | (mbar) | Circuit Status* |
| 900 | 100%/12.3 V | 16 | 803 | C |
| | | 17 | | NC |
| 900 | 69%/10.3 V | 20 | 820 | C |
| | | 21 | | NC |
| 900 | 55%/8.3 V | 20 | 819 | C |
| | | 22 | 826 | C |
| | | 24 | 835 | C |
| | | 25 | 838 | C |
| | | 26 | | NC |

*C = Controlling NC = Not Controlling

At a simulated atmospheric pressure of about 900 mbar and a pump duty cycle setting of 100% (12.3V), the exhaust gas analysis system pressure control circuit failed to control the sample pressure at pressure board settings greater than 16 (corresponding to a sample pressure of about 803 mbar). At this simulated atmospheric pressure, pump duty cycle setting, and sample pressure, the flow rate through the exhaust gas analysis system was about 6.0 L/min.

At a simulated atmospheric pressure of about 900 mbar and a pump duty cycle setting of 69% (10.3V), the exhaust gas analysis system pressure control circuit failed to control the sample pressure at pressure board settings greater than 20 (corresponding to an sample pressure of about 820 mbar). At this simulated atmospheric pressure, pump duty cycle setting, and sample pressure, the flow rate through the exhaust gas analysis system was about 5.1 L/min.

At a simulated atmospheric pressure of about 900 mbar and a pump duty cycle setting of 55% (8.3V), the exhaust gas analysis system pressure control circuit failed to control the sample pressure at pressure board settings greater than 25 (corresponding to an sample pressure of about 838 mbar). At this simulated atmospheric pressure, pump duty cycle setting, and sample pressure, the flow rate through the exhaust gas analysis system was about 4.4 L/min.

TABLE 3
Simulated Atmospheric Pressure of about 800 mbar

| Absolute | Pump Duty Cycle | Pressure | | Exhaust Gas |
|---|---|---|---|---|
| Pressure Meter | (%) & | Board | Sample | Analysis System |
| Reading | Pump Voltage | Setting | Pressure | Pressure Control |
| (mbar) | (V) | (%) | (mbar) | Circuit Status* |
| 800 | 100%/12.3 V | 0 | 739 | NC |
| 800 | 69%/10.3 V | 0 | 739 | NC |
| 800 | 55%/8.3 V | 0 | 739 | C |
| | | 2 | 747 | C |
| | | 3 | 751 | C |
| | | 4 | | NC |
| 800 | 50%/7.5 V | 3 | 751 | C |
| | | 4 | 755 | C |
| | | 5 | | NC |

*C = Controlling NC = Not Controlling

At a simulated atmospheric pressure of about 800 mbar and at pump duty cycle settings of 100% (12.3V) and 69% (10.3V), the exhaust gas analysis system pressure control circuit failed to control the sample pressure. At a simulated atmospheric pressure of about 800 mbar, and a pump duty cycle of 55% (8.3V), the exhaust gas analysis system pressure control circuit failed to control the sample pressure at pressure board settings greater than 3 (corresponding to a sample pressure of about 751 mbar). At this simulated atmospheric pressure, pump duty cycle setting, and sample pressure, the flow rate through the exhaust gas analysis system was about 3.8 L/min.

At a simulated atmospheric pressure of about 800 mbar and a pump duty cycle setting of 50% (7.5V), the exhaust gas analysis system pressure control circuit failed to control sample pressure at pressure board settings greater than 4 (corresponding to a sample pressure of about 755 mbar). At this simulated atmospheric pressure, pump duty cycle setting, and sample pressure, the flow rate through the exhaust gas analysis system was about 3.5 L/min.

Several observations can be made about the performance of the pressure controlled sampling system under varying atmospheric pressure conditions. First, at a given atmospheric pressure, lower pump duty cycle (pump voltage) results in lower flow rate through the exhaust gas analysis system. This suggests that as the power supply voltage to the pump changes, the sample delay times through the exhaust gas analysis system will also change. The addition of a regulated power supply for the sample pumps should ensure consistent sample delay times at a given atmospheric pressure.

In addition, for a given pump duty cycle, as the atmospheric pressure decreases, the differential required between atmospheric pressure and the sample pressure for control to be maintained by the pressure control circuit decreases. Under the experimental set-up used for Experiment 1, the minimum pressure differential required with a minimum flow rate of about 4 l/min is about 50 mbar. To accommodate moderate changes in atmospheric pressure that might occur due to either atmospheric conditions or altitude changes, a minimum pressure differential of 100 mbar is recommended.

Experiment 2

The equipment for the exhaust gas analysis system which was used in Experiment 1 did not permit simulating pressures below approximately 740 mbar. However, lower sample pressures might be required to accommodate atmospheric pressures typically experienced at higher altitudes, such as Denver, Colo. (atmospheric pressure about 825 mbar). Therefore, the equipment was modified so that lower simulated pressures could be obtained.

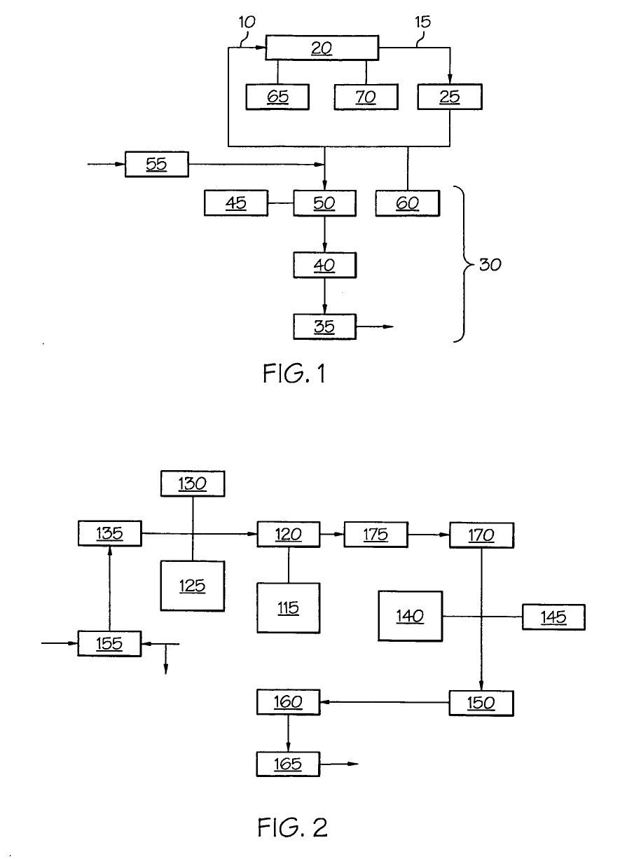

FIG. 2 is a block diagram of the experimental setup used in Experiment 2. External equipment was used in conjunction with the exhaust gas analysis system to simulate the changes in atmospheric pressure and to evaluate the effects of such changes on sample delay times. A regulated power supply 115 was added to control the sample pumps in the exhaust gas analysis system 120. It was used to maintain the sample pump voltage at 11.5 volts. The pressures at the inlet and outlet of the exhaust gas analysis system 120 were controlled and monitored using external pressure control circuitry and associated hardware. The equipment on the inlet side included pressure control circuitry 125, absolute pressure gauge 130, and pressure control valve 135. Similarly, the outlet side included pressure control circuitry 140, absolute pressure gauge 145, and pressure control valve 150.

On the inlet side of the exhaust gas analysis system 120, toggle valve 155 was used to select either a sample of ambient air or a sample of a standard gas. On the outlet side of the exhaust gas analysis system 120, ballast 160 was positioned after pressure control valve 150 to dampen pressure fluctuations created by the 12V vacuum pump 165. Mass flow meter 170 was employed on the outlet side of the exhaust gas analysis system 120, prior to pressure control valve 150, to monitor sample flow rates. Dryer 175 was placed inline prior to mass flow meter 170 because the particular exhaust gas analysis system 120 used in this experiment had been used previously in actual vehicle studies and still contained small amounts of water in the filtering system.

Software (MBWin.exe software obtained from Sensor, Inc. and modified in-house (version 1-97F) to accommodate certain algorithms for the IR analysis), was used to acquire the time delay data. The software was used to obtain voltage values from the gas analyzer and convert those values into concentration units. It was modified to display the concentration units calculated using calibration equations to correct the analysis of a specific compound for the effects of other compounds present in the exhaust stream.

The data acquisition rate was determined by the rate at which the gas analyzer measured the voltages for each of the data channels, and it was determined to be about 1.6 Hz. For each trial conducted, a data file of 100 data points was acquired. Injections of a standard sample gas were used to determine the actual delay times. Toggle valve 155 was switched between a sample line carrying a gas consisting of about 30% CO₂ (in N₂) and a sample line carrying filtered ambient air. The NDIR (non-dispersive infrared) CO₂ detector voltage was monitored using the MBWin.exe software to determine the delay times associated with the system.

The sample delay time is the time required for the sample gas to travel from the introduction point to the gas analyzer. The voltage of the NDIR channel pertaining to the compound of interest was monitored to determine the time it took for the sample to travel from the introduction point to the NDIR cell. The longer the sample line, the greater the sample delay time. It is desirable to minimize the distance between the sample introduction point and the gas analyzer so that the sample delay time is a fairly accurate estimate of the sample delay through the gas analyzer itself.

The data acquisition was initiated with the toggle valve 155 sampling the filtered air. After exactly 40 data points (about 25 seconds), the toggle valve 155 was switched to the CO₂ sample line. The CO₂ was allowed to flow for exactly 30 data points (about 19 seconds), at which time, the toggle valve 155 was switched back for the remainder of the data file. Thus, each trial provided a delay time corresponding to a falling edge (voltage drop due to the introduction of CO₂) and a rising edge (voltage increase due to the reintroduction of air). A minimum of 30 data points for each toggle valve setting provided ample time for the voltage to reach and maintain a plateau. Thus, the time delay associated with the rise and fall in the channel voltage could be accurately measured. Four trials were performed at each atmospheric pressure/sample pressure setting. The delay times were recorded, and the average of the delay times measured for all valid trials was calculated.

The simulated atmospheric pressure was varied in increments of 50 mbar from a setting of about 975 mbar down to the lowest atmospheric pressure at which the exhaust gas analysis system could control the sample pressure properly, which is about 100 mbar greater than the desired sample pressure. The study was conducted at three instrument (sample) pressure settings: about 600 mbar, about 725 mbar and about 860 mbar. The individual and the average delay times measured at the various atmospheric pressure settings for each of the three instrument settings are presented in Tables 4, 5, and 6.

TABLE 4
Measured Delay Times for Simulated Atmospheric Pressures
Ranging from 725 to 975 mbar for an
Instrument Operation Pressure of about 600 mbar

| | | | Measured | Measured | |
|---|---|---|---|---|---|
| | | | Delay | Delay | Average of |
| Simulated | | Mass | Times | Times | Measured |
| Atmospheric | Instrument | Flow | Falling | Rising | Delay |
| Pressure | Pressure | Rate | Edge* | Edge** | Times |
| (mbar) | (mbar) | (l/min) | (sec) | (sec) | (sec) |
| 975 | 603 | 1.8 | 5.58 | 6.20 | |
| | | | 5.58 | 6.82 | |
| | 603 | 1.9 | 5.58 | 5.58 | |
| | | | 4.96 | 6.20 | 5.81 |
| 925 | 603 | 2.3 | 6.20 | 5.58 | |
| | | | 4.96 | NA | |
| | 603 | 2.2 | 5.58 | 5.58 | |
| | | | 4.96 | 5.58 | 5.49 |
| 875 | 603 | 2.5 | NA | 5.58 | |
| | | | 4.96 | 4.96 | |
| | 603 | 2.3 | 4.34 | 4.34 | |
| | | | 4.96 | 4.34 | 4.78 |
| 825 | 603 | 2.5 | 4.34 | 3.72 | |
| | | | 4.34 | 3.72 | |
| | 603 | 2.4 | NA | 4.34 | |
| | | | 4.34 | 4.34 | 4.16 |
| 775 | 603 | 2.5 | 4.34 | 3.72 | |
| | | | 4.34 | 3.72 | |
| | | | 3.72 | 3.10 | |
| | | | 3.10 | 4.34 | 3.80 |
| 725 | 603 | 2.8 | 3.10 | 3.10 | |
| | | | 4.34 | 3.72 | |
| | | | 3.72 | 3.10 | |
| | | | 3.72 | NA | 3.54 |

*Falling Edge = First occurrence of a CO₂ channel voltage below the average voltage value (+/−3 σ) corresponding to air sample.
**Rising Edge = First occurrence of a CO₂ channel voltage above the average voltage value (+/−3 σ) corresponding to CO₂ sample.

TABLE 5
Measured Delay Times for Simulated Atmospheric Pressures Ranging
from 825 to 975 mbar for an Instrument Operating Pressure of 725 mbar

| | | | Measured | Measured | |
|---|---|---|---|---|---|
| | | | Delay | Delay | |
| Simulated | | Mass | Times | Times | Average of |
| Atmospheric | Instrument | Flow | Falling | Rising | Measured |
| Pressure | Pressure | Rate | Edge | Edge | Delay Times |
| (mbar) | (mbar) | (l/min) | (sec) | (sec) | (sec) |
| 975 | 725 | 2.9 | 3.72 | 3.72 | |
| | | | NA | 4.34 | |
| | | | 4.34 | 3.72 | |
| | | | 4.34 | 3.72 | 3.99 |
| 925 | 725 | 3.9 | 3.72 | 4.34 | |
| | | | 3.72 | 3.10 | |
| | | | 3.10 | 4.34 | |
| | | | 3.72 | 3.72 | 3.72 |
| 875 | 725 | 4.5 | 3.10 | 3.72 | |
| | | | 3.10 | 3.72 | |
| | | | 3.72 | 3.72 | |
| | | | 2.48 | 3.72 | 3.41 |
| 825 | 725 | 5.1 | 2.48 | 3.72 | |
| | | | 3.10 | 3.10 | |
| | | | 2.48 | 2.48 | |
| | | | 3.72 | 3.10 | 3.02 |

TABLE 6
Measured Delay Times for Simulated Atmospheric Pressures Ranging
from 950 to 975 mbar for an Instrument Operating Pressure of 860 mbar

| | | | Measured | Measured | |
|---|---|---|---|---|---|
| | | | Delay | Delay | |
| Simulated | | Mass | Times | Times | Average of |
| Atmospheric | Instrument | Flow | Falling | Rising | Measured |
| Pressure | Pressure | Rate | Edge | Edge | Delay Times |
| (mbar) | (mbar) | (l/min) | (sec) | (sec) | (sec) |
| 975 | 860 | 4.2 | NA | 3.72 | |
| | | | 2.48 | 3.10 | |
| | | | 3.10 | 2.48 | |
| | | | 3.10 | 2.48 | 2.92 |
| 950 | 860 | 5.2 | 2.48 | 2.48 | |
| | | | 3.10 | 3.10 | |
| | | | 2.48 | 2.48 | |
| | | | 3.10 | 3.10 | 2.79 |

The results of this experiment indicate that with a consistent voltage of 11.5V applied to the sample pumps, the mass flow rates measured at a given instrument pressure increased with decreasing atmospheric pressure, while the average of the sample delay times decreased. This suggests that if the exhaust gas analysis system were used to evaluate emissions from a vehicle traveling from a location at or slightly above sea level to a location at much higher altitude, the sample delays times would vary measurably during the travel period. In the extreme case, if the instrument pressure were set at about 600 mbar to accommodate all altitude/atmospheric pressures changes likely to occur during real world driving, the maximum change in the time delay resulting from a 250 mbar change in pressure (corresponding to a change in altitude of about 7500 feet) would be about 2.5 seconds.

Even in a more moderate case, if the instrument pressure were set at about 725 mbar, to accommodate atmospheric pressure changes of about 100 mbar, corresponding to altitudes of up to about 5500 feet, changes in delay times would be on the order of 1 second. Such changes in delay times are significant and would result in the incorrect alignment of the vehicle parameter and emissions data, creating errors in the mass emission values generated. In order to maximize the accuracy of the real-time mass emission data acquired using the exhaust gas analysis system, it is recommended that changes in altitude resulting in atmospheric pressure changes of greater than 50 mbar be avoided, unless the data is acquired in altitude “bins” with atmospheric pressures differences of 50 mbar or less. This could be done by adjusting the instrument pressure for every 50 mbar change in ambient pressure. For example, for ambient pressures between 900 and 950 mbar, one instrument pressure setting would be used to achieve a given sample delay time. For ambient pressures of 850 to 900 mbar, a slightly different instrument pressure would be used to achieve the same sample delay time. Similar adjustments would be made for each 50 mbar pressure change. Thus, to maintain system accuracy, sample delay times can be adjusted appropriately prior to data acquisition.

Experiment 3

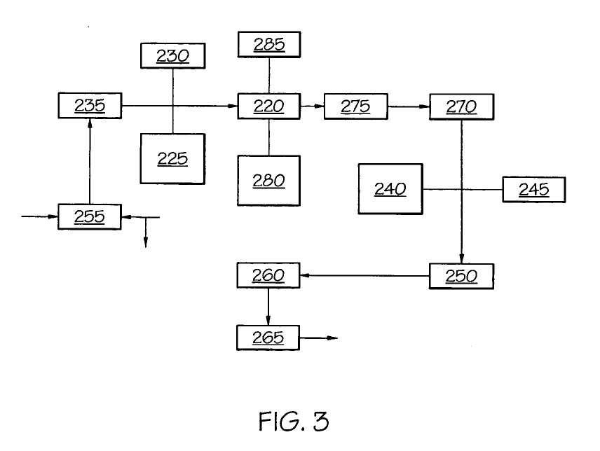

The experimental set-up for Experiment 3, shown in FIG. 3, is similar to that used in Experiment 2. The pressures at the inlet and outlet of the exhaust gas analysis system 220 were controlled and monitored using external pressure control circuitry and associated hardware. The equipment on the inlet side included pressure control circuitry 225, absolute pressure gauge 230, and pressure control valve 235. Similarly, the outlet side included pressure control circuitry 240, absolute pressure gauge 245, and pressure control valve 250.

On the inlet side of the exhaust gas analysis system 220, toggle valve 255 was used to select either a sample of ambient air or a sample of a standard gas. On the outlet side of the exhaust gas analysis system 220, ballast 260 was positioned after pressure control valve 250 to dampen pressure fluctuations created by the 12V vacuum pump 265. Mass flow meter 270 was employed on the outlet side of the exhaust gas analysis system 220, prior to pressure control valve 250, to monitor sample flow rates. Dryer 275 was placed inline prior to mass flow meter 270 because the particular exhaust gas analysis system 220 used in this experiment had been used previously in actual vehicle studies and still contained small amounts of water in the filtering system.

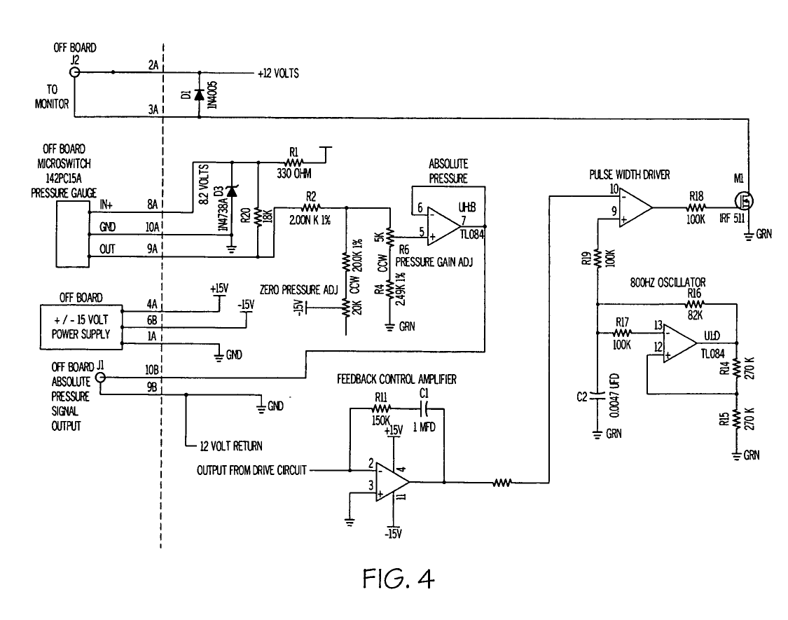

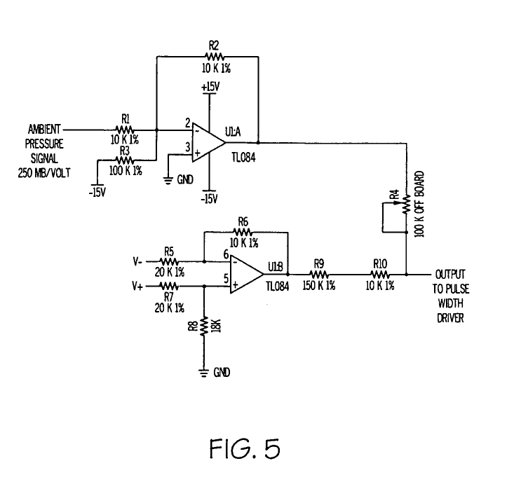

To eliminate changes in sample pump speed (and hence changes in sample gas delay times) due to variations in the available battery power, pulse width modulated pump control (PWMPC) circuitry 280 was added to regulate the power supplied to the sample pumps in the exhaust gas analysis system 220. A circuit diagram for one embodiment of PWMPC circuitry is shown in FIG. 4. In addition, constant delay time motor control (CDTMC) circuitry 285 was added to the system. A circuit diagram for one embodiment of CDTMC circuitry is shown in FIG. 5. The CDTMC circuitry 285 senses atmospheric pressure changes and sends a modified output to the PWMPC circuitry 280 to regulate pump speed and maintain constant gas sample delay times. In the CDTMC circuitry shown in FIG. 5, sample gas delay times can be set to the desired value by adjusting a variable resistor (R4) to the required resistance.

The validation study was conducted at a single instrument pressure of about 700 mbar. The CDTMC circuitry was used to set delay times at 3.5 and 5.0 seconds. Atmospheric pressures from 975 mbar to 775 mbar at 50 mbar increments were studied. The actual sample delay times were determined using the same procedure described in Experiment 2. Four trials were performed at each atmospheric pressure setting. A falling edge and a rising edge time delay value was determined for each valid trial. The average of the sample delay times was calculated for each atmospheric pressure level. The results of the circuit validation study for the settings of 3.5 and 5.0 seconds delay times are presented in Tables 7 and 8, respectively.

TABLE 7
Measured Delay Times for Simulated Atmospheric Pressures
Ranging from 775 to 975 mbar for an Instrument Operating Pressure
of about 700 mbar and a Set Sample Delay Time of 3.5 seconds

| | | | | | Average |
|---|---|---|---|---|---|
| Simulated | | Mass | Measured | Measured | Measured |
| Atmospheric | Pump | Flow | (FE)* | (RE)** | Delay |
| Pressure | Voltage | Rate | Delay Time | Delay Times | Time |
| (mbar) | (volts) | (l/min) | (sec) | (sec) | (sec) |
| 975 | 11.2 | 3.7 | 3.72 | | |
| | | | 3.10 | 4.34 | |
| | | | 3.10 | 3.10 | |
| | | | 4.34 | 3.72 | 3.63 |
| 925 | 10.3 | 4.0 | 3.72 | 3.10 | |
| | | | 3.10 | 3.72 | |
| | | | 3.10 | 3.10 | |
| | | | 3.10 | 3.72 | 3.33 |
| 875 | 9.4 | 3.4 | 3.10 | 2.48 | |
| | | | 3.72 | 3.72 | |
| | | | 2.48 | 3.72 | |
| | | | 3.72 | 3.10 | 3.26 |
| 825 | 8.5 | 3.1 | 3.72 | 3.72 | |
| | | | 2.48 | 3.72 | |
| | | | 3.72 | 2.10 | |
| | | | 3.72 | 3.72 | 3.49 |

*(FE) = Falling Edge; First occurrence of a CO₂ channel voltage below the average voltage value (+/−3 σ) corresponding to N₂sample.
**(RE) = Rising Edge; First occurrence of a CO₂ channel voltage above the average voltage value (+/−3 σ) corresponding to CO₂ sample.

TABLE 8
Measured Delay Times for Simulated Atmospheric Pressures
Ranging from 775 to 975 mbar for an Instrument Operating Pressure
of about 700 mbar and a Set Sample Delay Time of 5.0 seconds

| | | | | | Average |
|---|---|---|---|---|---|
| Simulated | | Mass | Measured | Measured | Measured |
| Atmospheric | Pump | Flow | (FE) | (RE) | Delay |
| Pressure | Voltage | Rate | Delay Time | Delay Times | Time |
| (mbar) | (volts) | (l/min) | (sec) | (sec) | (sec) |
| 975 | 7.9 | 2.6 | 4.96 | 4.96 | |
| | | | 4.34 | 5.58 | |
| | | | 4.34 | 4.96 | |
| | | | 4.34 | 4.96 | 4.81 |
| 925 | 7.2 | 2.9 | 4.96 | 5.58 | |
| | | | 4.96 | 4.96 | |
| | | | 4.96 | 4.34 | |
| | | | 4.96 | 4.34 | 4.88 |
| 875 | 6.6 | 2.6 | 4.34 | 4.96 | |
| | | | 4.34 | 4.34 | |
| | | | 4.34 | 4.96 | |
| | | | 4.96 | 5.58 | 4.73 |
| 825 | 6.0 | 2.0 | 4.96 | 5.58 | |
| | | | 4.96 | 4.96 | |
| | | | 4.96 | 4.96 | |
| | | | 5.58 | 4.96 | 5.12 |

The data presented in Tables 7 and 8 indicate that the CDTMC circuit controls to the requested delay times quite well. In the case of the 5.0 second delay time setting, the average of the average measured delay times for all four atmospheric pressure levels is 4.88 second with a standard deviation of 0.08 second. For the 3.5 second delay setting, the average of the average measured delay times for all four atmospheric pressure levels is 3.43 second with a standard deviation of 0.17 second. For purposes of comparison, in a previous study which was conducted at the same atmospheric pressures and under a similar instrument pressure (about 725 mbar) and in which the CDTMC circuit was not employed (hence pump voltage remained at a constant value of 11.5 volts), the average of the average measured delay time at all four atmospheric pressure settings was 3.53 seconds with a standard deviation of 0.41 second.

Experiments 1 and 2 showed that changes in atmospheric pressure due to atmospheric conditions or changes in altitude can cause variations in the sample delay times associated with the exhaust gas analysis system. Since precise time alignment of the exhaust gas concentrations measured by the exhaust gas analysis system and the vehicle parameter data obtained from the PCM is desirable in order to ensure the accuracy of the system, significant variations in the sample delay times are undesirable. As shown in this experiment, the addition of the pulse width modulated pump control circuitry and the constant delay time motor control circuitry to the exhaust gas analysis system will enable reduction in the variation of sample delay times associated with changes in atmospheric pressure and improve the accuracy of the system.

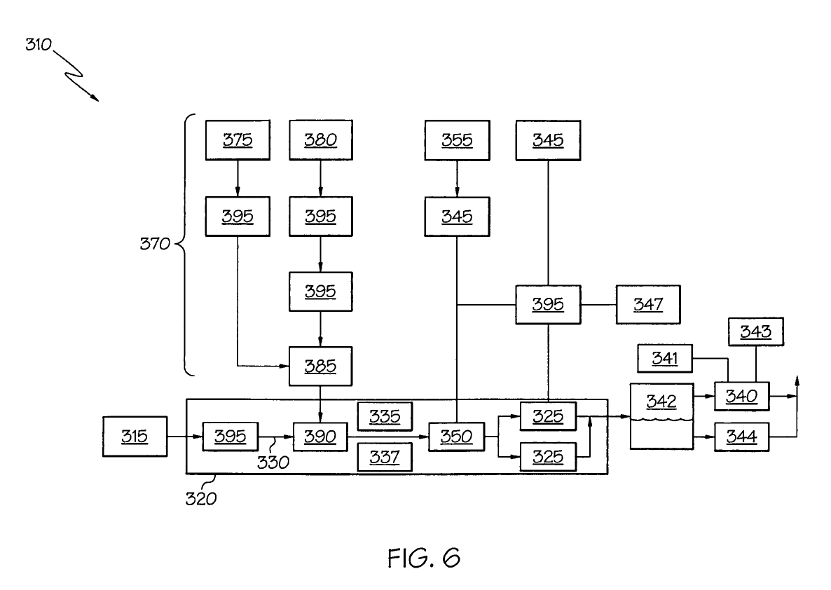

FIG. 6 shows the details of the exhaust gas analysis system which was tested in Experiments 1, 2, and 3. The exhaust gas analysis system 310 has a heated sample line 315 entering one end of an analyzer compartment 320. The analyzer compartment 320 includes one or more gas analyzers 325 to analyze the composition of the exhaust gas. Various types of gas analyzers are suitable for use in the system, depending on the type and amount of the exhaust species of interest. Suitable gas analyzers include, but are not limited to, infrared analyzers, ultraviolet analyzers, mass spectrometers, and mass analyzers. More than one type of analyzer can be included in the system. For example, and infrared analyzer could be used for some gases, such as carbon monoxide (CO), carbon dioxide (CO₂), and hydrocarbons (HC), while an ultraviolet analyzer could be used for other gases, such as of oxides of nitrogen (NO).

Although the gas sample does not have to be diluted in this system, it can be diluted if desired. Dilution of the sample gas would affect the selection of the gas analyzer because of the effect it has on the detection limits of the gas analyzer.

To ensure the accurate analyses of the exhaust gas using these techniques, the gas sample should be maintained at a constant temperature and pressure as it passes through the gas analyzer. This is achieved independent of the vehicle exhaust gas temperature and pressure. The analyzer compartment 320 should be maintained at a constant temperature to prevent condensation of any water and water-soluble components contained in the exhaust gas sample. One or more temperature sensors 330 measure the temperature of the gas sample. Suitable temperature sensors can be any small and fast sensor having an appropriate temperature range. Temperature sensors having a temperature range of about 25° C. to about 100° C. would be useful, although other temperature ranges could be used, as is well known in the art. Examples of suitable temperature sensors include, but are not limited to, diodes, thermistors, and thermocouples. If desired, temperature sensors incorporating temperature control circuitry, such as a thermostat, can be used to control one or more heaters 335. Alternatively, the temperature control circuitry can be separate from the temperature sensors. A suitable constant temperature is 60° C., although other temperatures can be used. The analyzer compartment 320 can optionally include a fan 337 to circulate air in the analyzer compartment to assist in maintaining the constant temperature.

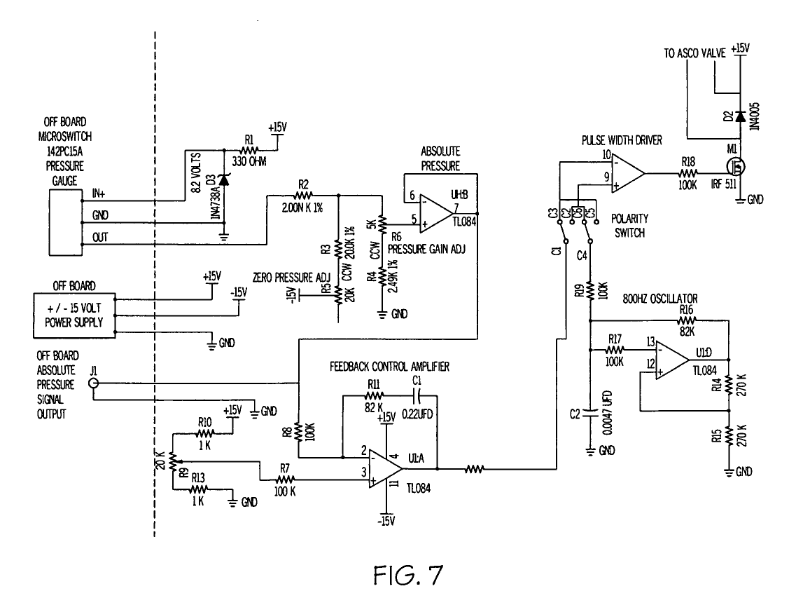

Constant pressure should be maintained in the analyzer compartment 320. This can be accomplished using one or more pressure sensors 345, pressure control valve 350, and associated pressure control circuitry 355. A leak check pressure sensor 347 can be included if desired. Pressure control valve 350 is situated in the sample line 315 upstream of the gas analyzer 325, and is responsive to pressure sensor 345. Suitable pressure control valves 350 include, but are not limited to, variable flow pressure control valves. One pressure sensor 345 can be located in the sample line 315 upstream of the gas analyzer 325, and a second pressure sensor can be located at the gas analyzer 325. The pressure sensor 345 upstream of the gas analyzer 325 is desirably positioned downstream of any filters or valves. It measures the absolute pressure of the sample gas. The second pressure sensor 345 at the gas analyzer 325 measures the pressure in the gas cell. Suitable pressure sensors 345 include, but are not limited to, absolute pressure gauges. The signal from pressure sensor 345 is compared to a fixed reference signal that corresponds to the desired absolute pressure. If the pressure is lower than desired, pressure control valve 350 is opened until the proper pressure is achieved. If the pressure is higher than desired, pressure control valve 350 is closed to maintain the correct pressure at the gas analyzer 325. This is a fairly simple system which can correct for a broad range of pressure variations that might occur in the sample gas. For example, it controls the pressure at the gas analyzer 325 effectively when sudden increases or decreases in the pressure of a vehicle exhaust sample occur during rapid acceleration or deceleration. Suitable pressure control circuitry is shown in FIG. 7, although other pressure control circuitry could be used as is well known in the art.

One or more sample pumps 340 draw the exhaust gas sample at constant reduced pressure (relative to atmospheric pressure) into and through the gas analyzer 325. The sample pumps 340 include a regulated power supply which is controlled by pulse width modulated pump control circuitry 341 and constant delay time motor control circuitry 343, examples of which are shown in FIGS. 4 and 5. The pulse width modulated pump control circuitry contains the pulse width driver that adjusts the voltage powering the DC pump motor. The constant delay time motor control circuitry determines the signal required to control the pump motor speed necessary to achieve a pre-set, fixed sample delay time. The required motor speed is a function of the ambient pressure. Suitable sample pumps 340 include, but are not limited to, vacuum pumps. Examples include, but are not limited to, constant displacement vacuum pumps. A coalescing filter 342 and a liquid pump 344 can also be included in the system, if desired.

Constant sample delay times may be achieved by regulating the power supplied to the sample pumps. To determine the pump voltage required for a given sample flow rate (sample delay time) at a given ambient pressure, a plot of pump voltage v. ambient pressure at a given sample inlet pressure (as measured at the gas analyzer) can be generated. The slope of the plot will be inversely proportional to the sample delay time. This relationship can be represented by the following equation:

$$Volts = \frac{[ Atmospheric Pressure ( mbar ) - {C}_{1} ( mbar ) ] * {C}_{2} ( volts / mbar sec )}{[ Sample Delay Time ( sec ) ]}$$

where C₁ and C₂ are constants that are determined by the nature of the analyzer, the type of sample pump, and the inlet pressure of the system.

Once the desired delay time is determined, and the ambient pressure is measured, the required pump voltage can be calculated and maintained using constant delay time motor control circuitry.

The exhaust gas analysis system 310 can optionally include a gas calibration component 370. The gas calibration component 370 can include one or more sources of calibration gas 375, 380. Calibration gases include gases which are components of the gas sample to be analyzed, such as carbon dioxide, various hydrocarbons, and oxides of nitrogen, among others. Calibration gases can also include ambient air, which is used to determine the voltage values for the baseline corrections for the gas analyzer 325. If more than one source of calibration gas 375, 380 is present, they can be connected by a valve 385. Valve 385 can be a three-way valve, or another suitable valve, so that either of the sources of calibration gas 375, 380 can be connected. The gas calibration component 370 can be connected to the sample line 315 by a valve 390. Valve 390 can also be a three-way valve or another suitable valve. Any type of valve can be used if the material it is made of will not react with the species in the sample.

The exhaust gas analysis system 310 can optionally include one or more filters 395, such as to remove particulate matter from the gas sample, as is well known in the art.

A microprocessor can optionally be included to calculate the mass emission rates of the species using the concentration data from the gas analyzer and data from the PCM including vehicle speed, load, and air/fuel ratio. The vehicle speed, load, and air/fuel ratio data could be obtained from a source other than the PCM if desired.

The exhaust gas analysis system of the present invention can be placed on-board a vehicle for real world driving analysis. It can also be used in stationary applications, such as in a laboratory.

While certain representative embodiments and details have been shown for purposes of illustrating the invention, it will be apparent to those skilled in the art that various changes in the compositions and methods disclosed herein may be made without departing from the scope of the invention, which is defined in the appended claims.

1. An exhaust gas analysis system, comprising:
a temperature control system maintaining a gas sample at constant temperature;
a pressure control system maintaining the gas sample at constant pressure;
a gas analyzer analyzing the gas sample;
a vacuum pump transferring the gas sample to the gas analyzer; and
a delay time control system maintaining a constant gas sample delay time through the exhaust gas analysis system.

2. The exhaust gas analysis system of claim 1 wherein the temperature control system comprises a temperature sensor, a heater, and temperature control circuitry operatively connected to the heater to maintain the gas sample at the constant temperature in response to a signal from the temperature sensor.

3. The exhaust gas analysis system of claim 2 wherein the temperature sensor is selected from diodes, thermistors, thermocouples, or thermostats.

4. The exhaust gas analysis system of claim 1 wherein the pressure control system comprises a pressure sensor, a pressure control valve, and pressure control circuitry operatively connected to the pressure control valve to maintain the gas sample at the constant pressure in response to the signal from the pressure sensor.

5. The exhaust gas analysis system of claim 4 wherein the pressure sensor is an absolute pressure gauge.

6. The exhaust gas analysis system of claim 4 wherein there are at least two pressure sensors.

7. The exhaust gas analysis system of claim 4 wherein the pressure control valve is a variable flow pressure control valve.

8. The exhaust gas analysis system of claim 1 the pump is a vacuum pump.

9. The exhaust gas analysis system of claim 8 wherein the vacuum pump is a constant displacement vacuum pump.

10. The exhaust gas analysis system of claim 1 wherein the delay time control system comprises pulse width modulated pump control circuitry operatively connected to the pump, and constant delay time motor control circuitry operatively connected to the pulse width modulated pump control circuitry to maintain the constant gas sample delay time.

11. The exhaust gas analysis system of claim 1 wherein gas analyzer is selected from infrared analyzers, ultraviolet analyzers, mass spectrometers, or mass analyzers.

12. The exhaust gas analysis system of claim 1 further comprising a filter for the gas sample.

13. The exhaust gas analysis system of claim 1 further comprising a calibration gas for the gas analyzer.

14. The exhaust gas analysis system of claim 1 further comprising a microprocessor calculating a mass emission rate for a gas species from a gas concentration obtained from the gas analyzer and an exhaust gas volume flow rate.

15. An exhaust gas analysis system, comprising:
a gas analyzer;
a sample line for a gas sample in fluid communication with the gas analyzer;
a temperature sensor;
a heater;
temperature control circuitry operatively connected to the heater to maintain the gas sample at a constant temperature in response to a signal from the temperature sensor;
a pressure sensor;
a pressure control valve in fluid communication with the sample line and an upstream side of the gas analyzer;
pressure control circuitry operatively connected to the pressure control valve to maintain the gas sample at a constant pressure in response to a signal from the pressure sensor;
a vacuum pump in fluid communication with a downstream side of the gas analyzer;
pulse width modulated pump control circuitry operatively connected to the vacuum pump to regulate the power supplied to the vacuum pump; and
constant delay time motor control circuitry operatively connected to the pulse width modulated pump control circuitry to maintain a constant gas sample delay time by regulating the power supplied to the vacuum pump.

16. The exhaust gas analysis system of claim 15 wherein the gas analyzer is selected from infrared analyzers, ultraviolet analyzers, mass spectrometers, or mass analyzers.

17. The exhaust gas analysis system of claim 15 wherein the temperature sensor is selected from diodes, thermistors, thermocouples, or thermostats.

18. The exhaust gas analysis system of claim 15 wherein the pressure sensor is an absolute pressure gauge.

19. The exhaust gas analysis system of claim 15 wherein there are at least two pressure sensors.

20. The exhaust gas analysis system of claim 15 wherein the pressure control valve is a variable flow pressure control valve.

21. The exhaust gas analysis system of claim 15 wherein the vacuum pump is a constant displacement vacuum pump.

22. The exhaust gas analysis system of claim 15 further comprising an analyzer compartment surrounding the gas analyzer.

23. The exhaust gas analysis system of claim 22 wherein a portion of the sample line, the temperature sensor, the pressure sensor, and the pressure control valve are located in the analyzer compartment.

24. The exhaust gas analysis system of claim 22 further comprising a fan to circulate air in the analyzer compartment.

25. The exhaust gas analysis system of claim 15 further comprising a filter in fluid communication with the sample line upstream of the gas analyzer.

26. The exhaust gas analysis system of claim 15 further comprising a source of calibration gas for the gas analyzer and a second valve in fluid communication with the source of calibration gas and the sample line.

27. The exhaust gas analysis system of claim 15 further comprising a microprocessor to calculate a mass emission rate for a gas species from a gas concentration obtained from the gas analyzer and an exhaust gas volume flow rate.

28. An exhaust gas analysis system, comprising:
means for maintaining a gas sample at a constant temperature;
means for maintaining the gas sample at a constant pressure;
means for pumping the gas sample through the exhaust gas analysis system;
means for maintaining a constant gas sample delay time through the exhaust gas analysis system; and
means for analyzing the gas sample.

29. The exhaust gas analysis system of claim 28 wherein the means for maintaining the gas sample at a constant temperature comprises a temperature sensor, a heater, and temperature control circuitry operatively connected to the heater to maintain the gas sample at a constant temperature in response to a signal from the temperature sensor.

30. The exhaust gas analysis system of claim 29 wherein the temperature sensor is selected from diodes, thermistors, thermocouples, or thermostats.

31. The exhaust gas analysis system of claim 28 wherein the means for maintaining the gas sample at a constant pressure comprises a pressure sensor, a pressure control valve, and pressure control circuitry operatively connected to the pressure control valve to maintain the gas sample at a constant pressure in response to the signal from the pressure sensor.

32. The exhaust gas analysis system of claim 31 wherein the pressure sensor is an absolute pressure gauge.

33. The exhaust gas analysis system of claim 31 wherein there are at least two pressure sensors.

34. The exhaust gas analysis system of claim 31 wherein the pressure control valve is a variable flow pressure control valve.

35. The exhaust gas analysis system of claim 28 the means for pumping the gas sample is a vacuum pump.

36. The exhaust gas analysis system of claim 35 wherein the vacuum pump is a constant displacement vacuum pump.

37. The exhaust gas analysis system of claim 28 wherein the means for maintaining the constant gas sample delay time comprises pulse width modulated pump control circuitry operatively connected to the means for pumping the gas sample, and constant delay time motor control circuitry operatively connected to the pulse width modulated pump control circuitry to maintain the constant gas sample delay time.

38. The exhaust gas analysis system of claim 28 wherein the means for analyzing a gas is selected from infrared analyzers, ultraviolet analyzers, mass spectrometers, or mass analyzers.

39. The exhaust gas analysis system of claim 28 further comprising a means for filtering the sample gas.

40. The exhaust gas analysis system of claim 28 further comprising means for calibrating the gas analyzer.

41. The exhaust gas analysis system of claim 28 further comprising means for calculating a mass emission rate for a gas species from a gas concentration obtained from the means for analyzing the gas sample and an exhaust gas volume flow rate.

42. A method for exhaust gas analysis comprising:
providing a gas sample for analysis;
maintaining the gas sample at constant temperature;
maintaining the gas sample at constant pressure;
providing a gas analyzer;
maintaining a constant gas sample delay time through the exhaust gas analysis system; and
analyzing the gas sample in the gas analyzer to provide a concentration of a gas species.

43. The method of claim 42 further comprising calculating a mass emission rate of the gas species from the concentration of the gas species.

44. The method of claim 43 further comprising determining vehicle speed, load, and air/fuel ratio, and calculating the mass emission rate from the concentration of the gas species and the vehicle speed, load, and air/fuel ratio.

45. The method of claim 42 wherein the constant pressure is less than atmospheric pressure.

46. The method of claim 42 wherein the constant pressure is at least about 100 mbar less than atmospheric pressure.

47. The method of claim 42 wherein the constant temperature is a temperature in a range from about 25 to about 100° C.

48. A method for exhaust gas analysis comprising:
providing an exhaust gas analysis system comprising:
a temperature control system maintaining a gas sample at constant temperature;
a pressure control system maintaining the gas sample at constant pressure;
a gas analyzer analyzing the gas sample;
a pump transferring the gas sample to the gas analyzer; and
a delay time control system maintaining a constant gas sample delay time through the exhaust gas analysis system;
selecting the constant temperature, the constant pressure, and the constant gas sample delay time;
maintaining the gas sample at the constant temperature, maintaining the gas sample at the constant pressure, and maintaining the constant gas sample delay time; and
frequently periodically analyzing the gas sample in the gas analyzer to obtain a concentration for one or more gas species.

49. The method of claim 48 wherein the constant pressure is less than atmospheric pressure.

50. The method of claim 48 wherein the constant pressure is at least about 100 mbar less than atmospheric pressure.

51. The method of claim 48 wherein the constant temperature is a temperature in a range from about 25 to about 100° C.

52. The method of claim 48 further comprising determining vehicle speed, load, and air/fuel ratio, and calculating a mass emission rate of the gas species from the concentration of the gas species and the vehicle speed, load, and air/fuel ratio.
